(19) United States
(12) Patent Application Publication
(10) Pub. No.: US 2022/0058986 A1
(43) Pub. Date: Feb. 24, 2022

(54) SEPARATION INDICATOR FOR HOTEL DOORS AND OTHER MOVEABLE OBJECTS

(71) Applicant: RIVAL BRANDING LLC, Lenexa, KS (US)

(72) Inventor: Trenton Marquardt, Lenexa, KS (US)

(73) Assignee: RIVAL BRANDING LLC, LENEXA, KS (US)

(21) Appl. No.: 17/000,536

(22) Filed: Aug. 24, 2020

(51) Int. Cl. G09F 3/10; G09F 3/02

(52) U.S. Cl. CPC G09F 3/10; G09F 2003/0239; G09F 2003/0269; G09F 3/02

(57) ABSTRACT

A separation indicator for indicating when a door has been opened. The separation indicator includes a substrate having opposed inner and outer surfaces and first and second portions, with an elongated tear line between the first and second portions. An adhesive material is applied to the inner surface of the substrate and a message, pattern, or design is printed on the outer face of the substrate. The indicator further comprises a series of perforations separated by uncut links along the tear line, with at least a part of the perforations being angled with respect to the tear line. The links hold the first and second portions of the substate together when the indicator is first placed on a door and break along the tear line when the door to which the indicator is attached is opened. Movement of the door to the open position causes the substrate to tear along the tear line while the first and second portions of the substrate remain adhered to the door and door jamb.

### BACKGROUND

The present invention relates to devices and methods for indicating when a door or other moveable object has been opened or otherwise moved. More particularly, the invention relates to a separation indicator for indicating when a hotel room door has been opened after its corresponding hotel room has been cleaned and/or sanitized.

Hotels, restaurants, airlines, and other organizations are enhancing their cleaning and sanitation protocols in response to the Covid-19 global pandemic. From more frequent and rigorous sanitation to revised employee training, these new protocols are intended to both keep guests safe and to provide notice that hotel rooms, bathrooms, aircraft, door handles, and other objects have been properly cleaned so guests can confidently enjoy the objects without further cleaning.

Among the new protocols in the hotel industry is a door seal sticker placed on each guestroom door indicating the room has been cleaned and has not been entered by other guests or hotel employees since the last cleaning. Such door seals effectively notify guests of cleaning and sanitation protocols and, once removed, notify housekeepers the rooms will require future cleaning. Unfortunately, these door seal stickers are difficult to remove and often leave glue residue behind and/or lift paint or stain from the doors, thus creating more cleaning and maintenance responsibilities for hotel workers.

### SUMMARY

The present invention solves the above-described problems and related problems by providing a more effective way to notify guests and other persons that a hotel room or other room or object has been properly cleaned without damaging the object or creating additional cleaning tasks.

One embodiment of the invention is a separation indicator for indicating when a door, such as a hotel room door, has been opened after the room to which the door is attached is cleaned. The indicator comprises a substrate formed of thin and flexible material such as paper or lightweight vinyl or plastic. An elongated tear line divides the substrate into first and second portions. The separation indicator further comprises an adhesive material applied to an inner surface of the substrate and a message such as “Cleaned and Sanitized” and/or a design, pattern, etc. printed on an outer face of the substrate.

The separation indicator is configured for placement in bridging relationship across a door and its corresponding door jamb, with the first portion of the substrate adhered to the door jamb and the second portion adhered to the door, or vice versa. The door and door jamb present an elongated seam between them when closed. The substrate is positioned so that its tear line generally aligns with this seam so that the substrate tears along the tear line when the door is opened to indicate that the room reached by the door has been entered.

To eliminate damage to the door and door jamb when the substrate is removed, the adhesive is preferably a removable type adhesive characterized by low initial tack and low ultimate adhesion. Such an adhesive allows the indicator to be quickly and easily removed without leaving bits of the substrate and/or residue behind and without lifting paint or stain from the door and door jamb.

To facilitate tearing of the substrate when the door is opened, the indicator further comprises a series of perforations along the tear line separated by uncut links. The links hold the first and second portions of the substate together when the indicator is first placed on the door and break along the tear line when the door to which the indicator is attached is opened. Importantly, at least some of the perforations are angled with respect to the tear line, the advantages of which are discussed below.

Because the substrate is held on the door and door jamb with a low adhesion, low tack adhesive, it is prone to being pulled off the door and/or door jamb when the door is opened rather than tearing along the tear line as intended. This is a problem because someone could enter the room and simply reapply the intact substrate without anyone knowing the room was entered. To prevent this, the perforations and links are designed and configured to easily tear along the tear line despite the weak adhesive. One such design feature that helps accomplish this is the orientation of the perforations. Specifically, because the perforations are angled relative to the tear line, the uncut links between the perforations are subjected to an angled tearing force even though the door moves about an axis that is parallel to the door seam. This angled tearing force more effectively tears the uncut links than if the perforations were aligned with the tear line as is typical with perforated paper.

To further facilitate easy tearing of the substrate, the uncut links between the perforations along the tear line are much smaller than the perforations and are spaced a sufficient distant apart so that a relatively small surface area of the substrate must tear in order for the substrate to separate.

The above-described separation indicator may be used as follows. The indicator is attached to a hotel room door and its corresponding door jamb when the door is closed after the room reached by the door has been cleaned. The first portion of the substrate is applied to the door jamb and the second portion applied to the door, with the tear line proximal to and in general alignment with the seam between the door and door jamb. The message on the indicator informs guests that the room reached by the door has been properly cleaned and sanitized and has not been entered since the cleaning. When the door is opened, the substrate tears along the tear line, with the first and second portions of the substrate remaining adhered to the door and door jamb. The torn indicator indicates the room has been entered and will eventually require additional cleaning before it is occupied by a new guest. Because the substrate is held on the door and door jamb with low adhesion adhesive, it can be quickly and easily removed and replaced with a fresh, untorn separation indicator after the room is cleaned again.

Although embodiments of the invention are particularly well suited for indicating when a hotel room door has been opened after its corresponding hotel room has been cleaned, the invention may also be used to indicate opening of doors leading to other types of rooms such as bathrooms, kitchens, etc. and may also be used to indicate actions other than room cleaning, such as maintenance, security checks, etc. Embodiments of the invention may also be used to indicate opening or movement of other objects such as airline tray tables, laptop computer screens, toilet seats, cash registers, lockers, etc.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a separation indicator constructed in accordance with an embodiment of the invention and shown applied to a closed door and its door jamb before the door has been opened and the separation indicator torn.

FIG. 2 is a perspective view of the separation indicator shown torn along its tear line after the door to which it is attached has been opened.

FIG. 3 is a front perspective view of the separation indicator.

FIG. 4 is a rear perspective view of the separation indicator.

FIG. 5 is an enlarged front elevational view of the separation indicator.

FIG. 6 is an enlarged front elevational view of a separation indicator constructed in accordance with another embodiment of the invention.

FIG. 7 is an enlarged fragmentary front elevational view of a separation indicator constructed in accordance with another embodiment of the invention.

FIG. 8 is an enlarged fragmentary front elevational view of a separation indicator constructed in accordance with another embodiment of the invention.

FIG. 9 is an enlarged fragmentary front elevational view of a separation indicator constructed in accordance with another embodiment of the invention.

FIG. 10 is an enlarged fragmentary front elevational view of a separation indicator constructed in accordance with another embodiment of the invention.

FIG. 11 is an enlarged fragmentary front elevational view of a separation indicator constructed in accordance with another embodiment of the invention.

FIG. 12 is an enlarged fragmentary front elevational view a separation indicator constructed in accordance with another embodiment of the invention.

FIG. 13 is a perspective view of two separation indicators constructed in accordance with embodiments of the invention, with one of the separation indicators shown applied to a closed tray table and the other separation indicator shown applied to an opened tray table.

The drawing figures do not limit the present invention to the specific embodiments disclosed and described herein. The drawings are not necessarily to scale, emphasis instead being placed upon clearly illustrating the principles of the invention.

### DETAILED DESCRIPTION

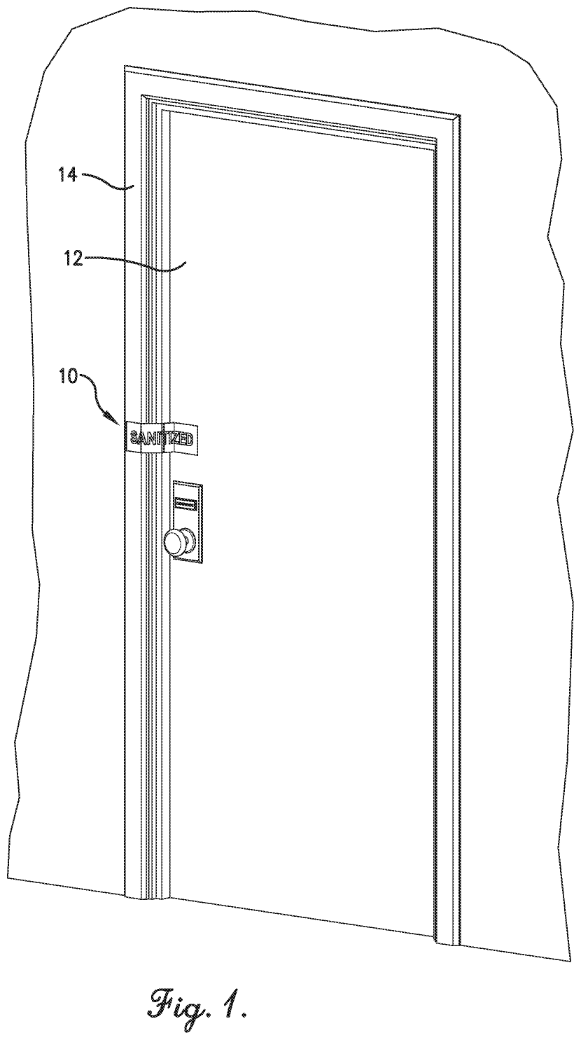

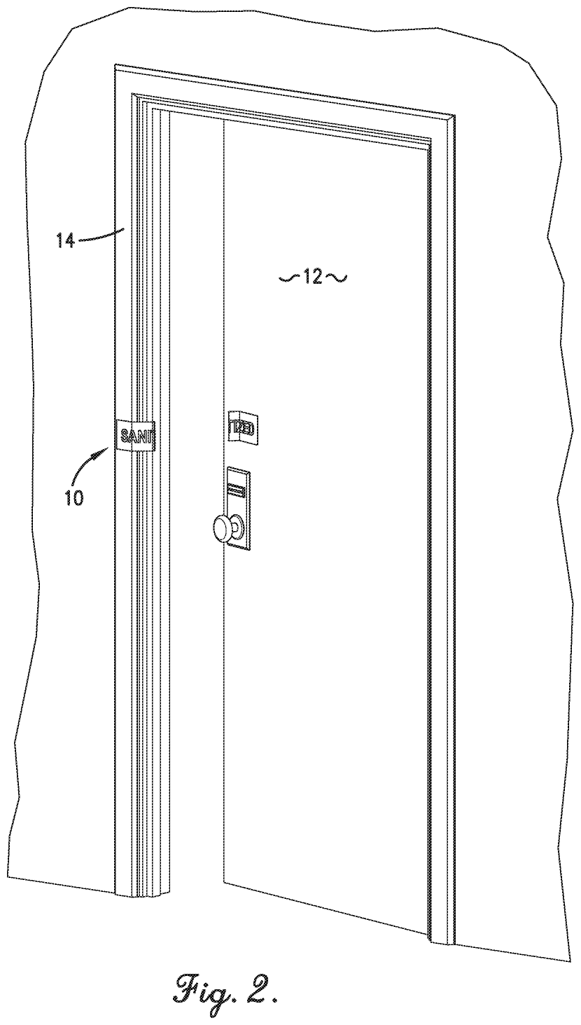

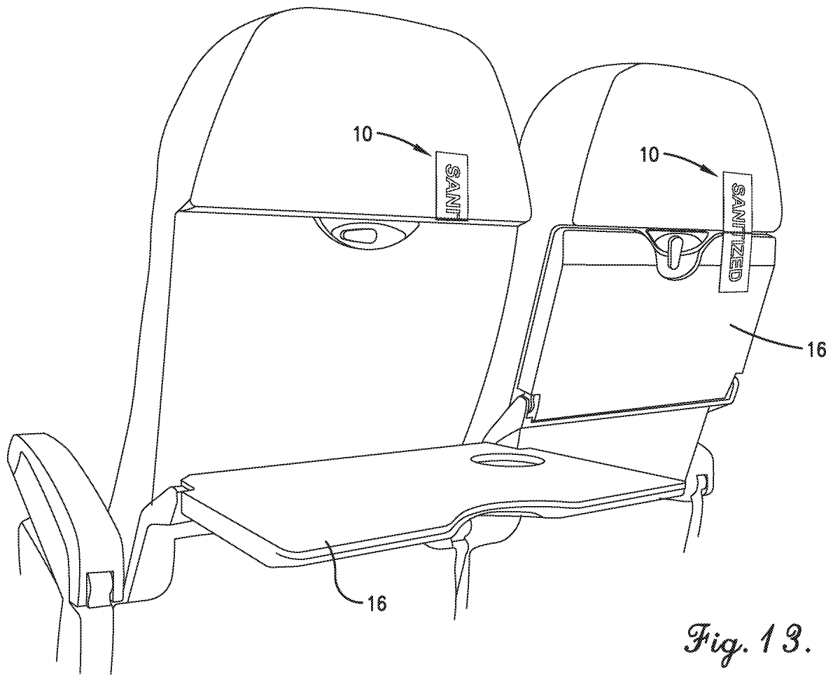

Turning now to the drawing figures, a separation indicator 10 constructed in accordance with an embodiment of the invention is illustrated in FIGS. 1-5. As illustrated in FIGS. 1 and 2, this embodiment of the separation indicator 10 is configured for indicating when a door 12, such as a hotel room door, bathroom door, office door, or gym door, has been opened with respect to its door jamb 14. As depicted in FIG. 13, other embodiments of the invention may be used to indicate opening or movement of airline tray tables 16. Still other embodiments of the invention may be used to indicate opening or movement of laptop computer screens, toilet seats, cash registers, lockers, etc. Because the construction of the separation indicator is basically the same for all applications, the following detailed description of the invention will primarily focus on the door and door jamb embodiment.

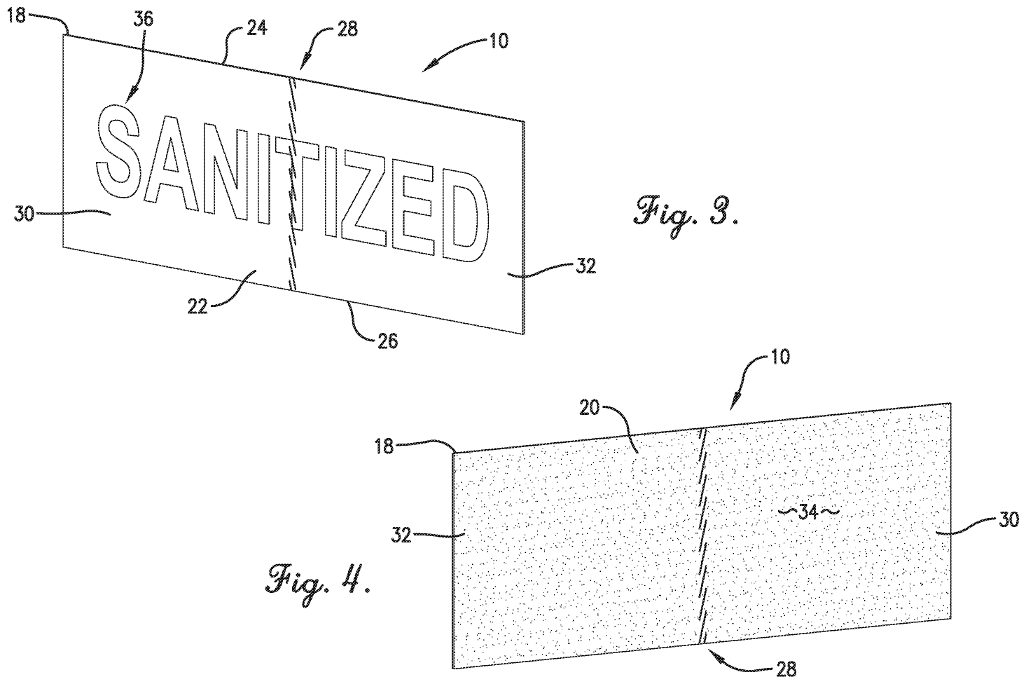

Turning now to FIGS. 3 and 4, the separation indicator 10 comprises a substrate 18 formed of thin, flexible material such as paper, plastic film, metallic foil, or vinyl. The substrate 18 may be any shape and size, and in some embodiments is square or rectangular and between 1-9 inches long and 1-9 inches tall. In one particular embodiment, the substrate is 2 inches tall and 6 inches long. In another embodiment, the substrate is 2 inches tall and 4 inches long. In another embodiment, the substrate is 1 inch tall and 6 inches long. The substrate is preferably no more than 0.035″ thick to facilitate easy tearing as described below. Applicant has discovered, via experimentation, that a substrate with these dimensions provides sufficient surface area for the adhesive to keep the substrate on the door and door jamb when the door is opened. But the substrate may be of any shape, size, and thickness without departing from the scope of the invention.

The substrate 18 has opposed inner and outer surfaces 20, 22, top and bottom edges 24, 26, and an elongated, vertically-extending tear line 28 extending between the top and bottom edges. The tear line 28 divides the substrate 18 into first and second portions 30, 32. For embodiments of the invention that are applied to objects that open and close about a horizontal axis, the tear line 28 may extend horizontally between right and left side margins of the substrate 18.

The separation indicator 10 further comprises an adhesive material 34 applied to the inner surface 32 of the substrate and a message 36 such as “Cleaned and Sanitized” and/or a pattern or design printed on the outer face 22 of the substrate. The adhesive 34 is preferably a removable type adhesive characterized by low initial tack and low ultimate adhesion. Such an adhesive allows easy removal of the indicator 10 from the door 12 and door jamb 14 without leaving bits of the substrate and/or residue behind and without lifting paint or stain from the door and door jamb. Exemplary adhesives that achieve the objectives of the present invention include Mactac MR860, an acrylic based removable adhesive, and UPM Raflatac RR22, an emulsion rubber removable adhesive. But other similar adhesives may also be used.

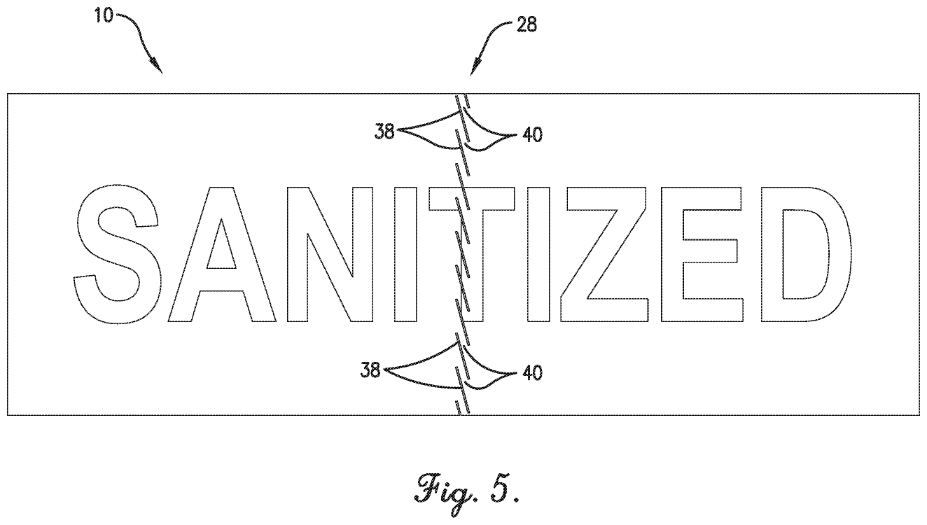

To permit tearing of the substate 10 along the tear line 28, the indicator further comprises a series of perforations 38 along the tear line separated by uncut links 40 as best shown in FIG. 5. The perforations 38 and links 40 are designed and configured to allow the substrate 18 to easily tear along the tear line 28 without pulling the first or second portions 30, 32 of the substrate off the door 12 and/or door jamb 14.

Conventional perforations typically consist of spaced-apart punched holes separated by uncut portions approximately the same size as the perforations. Applicant has discovered that such prior art perforations tear best when the substrate on opposite sides of the perforations are gripped and pulled apart at an angle, such as by pulling one side of the substrate at an upward angle and the opposite side at a downward angle.

But because the door 12 is hinged to the door jamb 14, it moves about an axis that is always parallel to the door seam between the door and door jamb and thus cannot create an angled tearing force to easily separate the substrate along the tear line. The perforations 38 and links 40 of the present invention are therefore designed and configured to mimic an angled tearing of the substate.

In the embodiment illustrated in FIGS. 3-5, the perforations 38 comprise linear slits that extend at an acute angle, such as 10-20 degrees, relative to the tear line. Each slit is between ⅛-½ inch long and 1/16-¼ inch wide. The links 40 between the slits 38 are 1/16-¼ inches wide, with the width being the shortest distance between two adjacent slits.

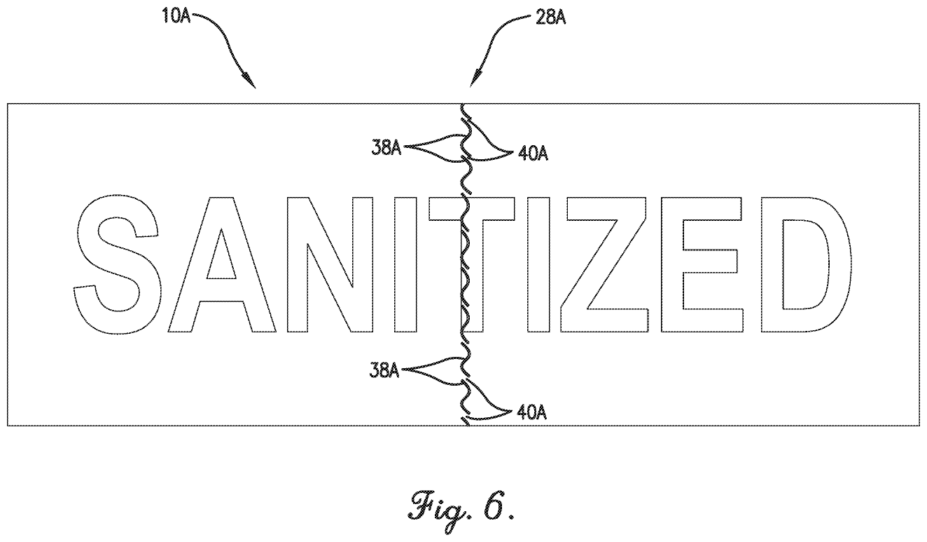

A separation indicator 10A constructed in accordance with another embodiment of the invention is illustrated in FIG. 6. The separation indicator 10A includes perforations 38A that comprise serpentine-shaped or sinusoidal-shaped slits that are each between ⅛-⅓ inch long and 1/16-¼ inch wide. The slits are separated by links 40A that are 1/16-¼ inches wide, with the width being the shortest distance between two adjacent slits.

A separation indicator 10B constructed in accordance with another embodiment illustrated in FIG. 7. The separation indicator 10B includes perforations 38B that comprise chevron-shaped slits each with two approximately perpendicular legs. Each leg is between ⅛-½ inch long and 1/16-¼ inch wide. The slits 38B are separated by links 40B that are 1/16-¼ inches wide, with the width being the shortest distance between two adjacent slits.

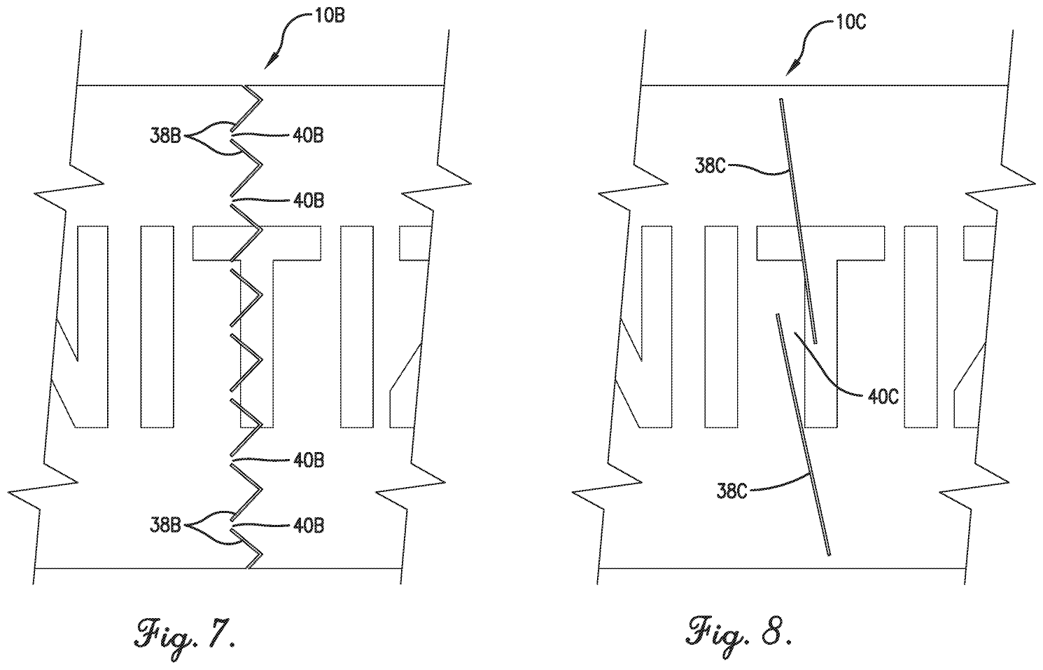

A separation indicator 10C constructed in accordance with another embodiment illustrated in FIG. 8. The separation indicator 10C includes perforations 36C that comprise two relatively longer linear slits that extend at an acute angle, such as 10-20 degrees, relative to the tear line. Each slit is between ½-3 inches long and 1/16-¼ inch wide. The slits are separated from each other and from the top and bottom edges of the substrate by links that are each 1/16-¼ inches wide, with the width being the shortest distance between two slits.

A separation indicator 10D constructed in accordance with another embodiment illustrated in FIG. 9. The separation indicator 10D includes perforations 38D that comprise angled V-shaped slits each with two legs separated by an acute angle. Each leg is between ¼-¾ inch long and 1/16-¼ inch wide and extends at an angle relative to the tear line. The slits are separated from each other and from the top and bottom edges of the substrate by links 40D that are 1/16-¼ inches wide, with the width being the shortest distance between two adjacent slits.

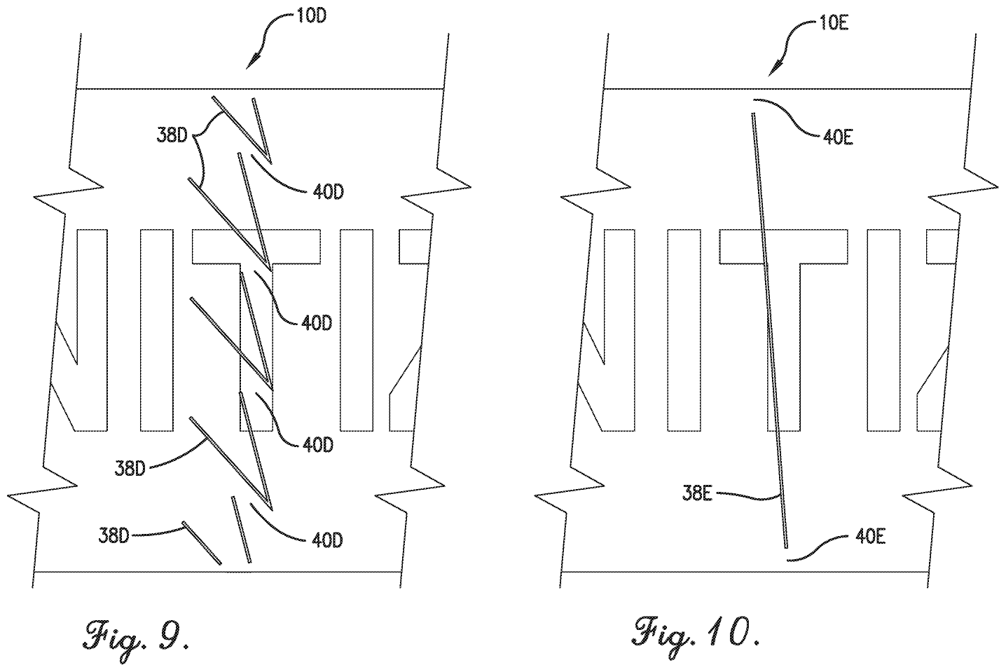

A separation indicator 10E constructed in accordance with another embodiment illustrated in FIG. 10. The separation indicator 10E includes perforations 38E that comprise one relatively longer linear slit that extends at an acute angle relative to the tear line. The slit is between 1-4 inches long and 1/16-¼ inch wide and its ends are separated from the top and bottom edges of the substate by links 40E that are 1/16-¼ inches wide, with the width being the shortest distance between slits and the substrate edges.

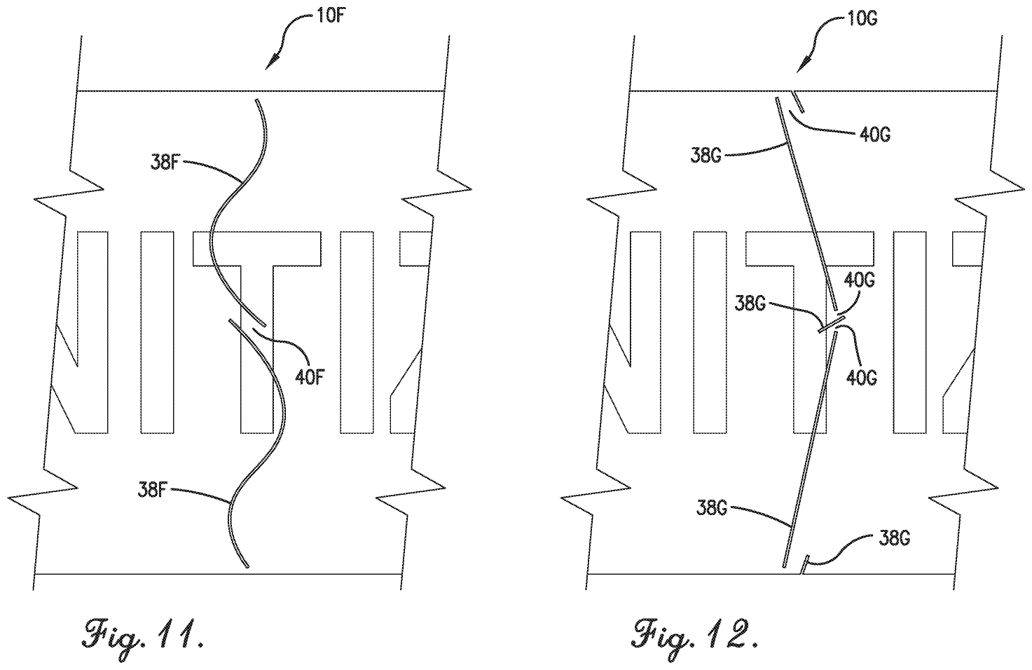

A separation indicator 10F constructed in accordance with another embodiment illustrated in FIG. 11. The separation indicator 10F includes perforations 38F that comprise two relatively longer serpentine-shaped or sinusoidal-shaped slits that are each between 1-3 inches long and 1/16-¼ inch wide. The slits are separated from each other and from the top and bottom edges of the substrate by links 40F that are each 1/16-¼ inches wide, with the width being the shortest distance between two slits.

A separation indicator 10G constructed in accordance with another embodiment illustrated in FIG. 12. The separation indicator 10G includes perforations 38G that comprise a number of different sized slits extending at several different angles with respect to the tear line. Particularly, the perforations include two relatively longer linear slits that extend at an acute angle relative to the tear line but an obtuse angle relative one another. The larger slits are between 1-3 inches long and 1/16-¼ inch wide. The perforations further include two relatively shorter linear slits each adjacent an end of one of the longer slits. These shorter slits also extend at an acute angle relative to the tear line but an obtuse angle relative one another. The slits are between ¼-½ inches long and 1/16-¼ inch wide. Finally, the perforations include a single relatively shorter slit between the longer slits. All of the slits are separated from each other and the top and bottom edges of the substate by links 40G that are 1/16-¼ inches wide, with the width being the shortest distance between two adjacent slits.

In all the above-described embodiments, significant portions of the perforations 38 extend at angles relative to the tear line 28 in the substrate 18. These angled portions of the perforations allow the substrate to tear along the tear line with an angular force even though the door moves along an axis that is parallel the seam between the door and door frame.

To further facilitate easy tearing of the substrate, the uncut links 40 interspaced between the perforations 38 are relatively small and spaced a sufficient distant apart. In one embodiment, the width of each uncut link is less than 25% of the length of each perforation so that the uncut links occupy a small part of the tear line. In another embodiment, the distance between adjacent uncut links is at least 4-5 times the width of each link and preferably more than 10 times the width. In another embodiment, the width of each uncut link is less than 30% of the length of each perforation so that the uncut links occupy a small part of the tear line.

Exemplary uses of the separation indicator 10 will now be discussed. As shown in FIGS. 1 and 2, the separation indicator 10 is configured for indicating when a door 12, such as a hotel room door, bathroom door, office door, gym door, etc. has been separated or opened with respect to its door jamb 14. The separation indicator is configured for placement in bridging relationship across the door and corresponding door jamb, with the door being movable between a closed position in which the door and door jamb present an elongated seam therebetween, and an open position where the door is moved from the door jamb.

The indicator 10 may be attached to the door and door jamb when the door is closed after a hotel room, bathroom, or other room reached by the door has been cleaned, with the first portion of the substrate 30 applied to the door jamb and the second portion 32 applied to the door, and the tear line 28 proximal to and in general alignment with the seam between the door and door jamb. Before it is torn, the indicator shows that the room reached by the door has been properly cleaned and sanitized and has not been entered since the cleaning as depicted in FIG. 1. Movement of the door to the open position causes the substrate to tear along the tear line while the first and second portions of the substrate remain adhered to the door and door jamb as depicted in FIG. 2. Once the indicator has torn, it indicates to hotel staff that the room is or has been occupied and will eventually require additional cleaning before it is occupied by a new guest. Because the substrate is held on the door and door jamb with low adhesion adhesive, it can be quickly and easily removed and replaced with a fresh, untorn separation indicator after the room is cleaned again.

Although embodiments of the invention are particularly well suited for use with hotel room doors, the invention may also be used to indicate opening of doors leading to other types of rooms such as bathrooms, kitchens, etc. Embodiments of the invention may also be used to indicate opening or movement of other objects such as airline tray tables, laptop computer screens, toilet seats, cash registers, lockers, etc.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A separation indicator for placement in bridging relationship across first and second objects which are relatively movable between a closed position where the objects are in proximity to each other and present an elongated seam therebetween, and an open position where the objects are separated from each other, the separation indicator comprising:
a substrate having opposed surfaces and first and second portions, with an elongated tear line between the first and second portions;
adhesive material applied to the first and second portions of one of the opposed surfaces,
the substrate and adhesive material configured for application of the separation indicator to the first and second objects when the first and second objects are in the closed position thereof, with the first portion applied to the first object and the second portion applied to the second object, and with the tear line proximal to and in general alignment with the seam; and
a series of perforations along the tear line, with at least a part of the perforations being angled with respect to the tear line, so that relative movement of the first and second objects to the open position causes the first and second portions to separate from one another along the tear line while remaining adhered to the first and second objects, in order to indicate the movement of the first and second objects from the closed to the open positions thereof

2. The separation indicator as set forth in claim 1, the adhesive material comprising a removable adhesive characterized by low initial tack and low ultimate adhesion.

3. The separation indicator as set forth in claim 1, further comprising a series of uncut links interspaced between the perforations along the tear line, wherein a width of each of the uncut links is less than 30% of a length of each of the perforations.

4. The separation indicator as set forth in claim 1, wherein a distance between adjacent uncut links is at least 4 times a width of each link

5. The separation indicator as set forth in claim 1, wherein the uncut links collectively occupy less than 30% of a length of the tear line.

6. The separation indicator as set forth in claim 1, wherein the substate is formed of paper, plastic film, metallic foil, or vinyl and is less than 0.05″ thick.

7. The separation indicator as set forth in claim 1, wherein each perforation is longer that it is wide.

8. The separation indicator as set forth in claim 1, wherein at least one of the perforations is curvilinear.

9. The separation indicator as set forth in claim 1, wherein at least one of the perforations is linear.

10. The separation indicator as set forth in claim 1, further comprising a message printed on one of the opposed surfaces of the substrate.

11. A separation indicator for placement in bridging relationship across a door and a corresponding doorjamb, the door being movable between a closed position in which the door and door jamb present an elongated seam therebetween, and an open position where the door is moved from the door jamb, the separation indicator comprising:
a substrate formed of thin and flexible material and having opposed inner and outer surfaces and first and second portions, with an elongated tear line between the first and second portions;
adhesive material applied to the inner surface of the substrate,
a message printed on the outer face of the substrate;
the substrate and adhesive material configured for application of the separation indicator to the door and door jamb when the door is in the closed position thereof, with the first portion of the substrate applied to the door jamb and the second portion applied to the door, and with the tear line proximal to and in general alignment with the seam; and
a series of perforations along the tear line, with at least a part of the perforations being angled with respect to the tear line, so that movement of the door to the open position causes the first and second portions to separate from one another along the tear line and to disrupt the message printed on the substrate while remaining adhered to the door and door jamb in order to indicate opening of door.

12. The separation indicator as set forth in claim 11, the adhesive material comprising a removable adhesive characterized by low initial tack and low ultimate adhesion.

13. The separation indicator as set forth in claim 11, further comprising a series of uncut links interspaced between the perforations along the tear line, wherein a width of each of the uncut links is less than 30% of a length of each of the perforations.

14. The separation indicator as set forth in claim 11, wherein the uncut links collectively occupy less than 40% of a length of the tear line.

15. The separation indicator as set forth in claim 11, wherein the uncut links collectively occupy less than 30% of a length of the tear line.

16. The separation indicator as set forth in claim 11, wherein the substate is formed of paper, plastic film, metallic foil, or vinyl and is less than 0.05″ thick.

17. The separation indicator as set forth in claim 11, wherein each perforation is longer than it is wide.

18. The separation indicator as set forth in claim 11, wherein at least one of the perforations is curvilinear.

19. The separation indicator as set forth in claim 11, wherein at least one of the perforations is linear.

20. The separation indicator as set forth in claim 11, wherein at least a part of the perforations are angled 10°-20° with respect to the tear line.
